(19) United States
(12) Patent Application Publication
(10) Pub. No.: US 2018/0096335 A1
(43) Pub. Date: Apr. 5, 2018

(54) SYSTEMS AND METHOD FOR ENABLING A DATA EXCHANGE

(71) Applicant: The Toronto-Dominion Bank, Toronto (CA)

(72) Inventors: Joe Moghaizel, Toronto (CA); Tricia Elizabeth Allen, Toronto (CA); Paul Mon-Wah Chan, Toronto (CA); John Jong-Suk Lee, Toronto (CA); Rakesh Thomas Jethwa, Toronto (CA)

(21) Appl. No.: 15/285,888

(22) Filed: Oct. 5, 2016

(51) Int. Cl. G06Q 20/22

(52) U.S. Cl. CPC G06Q 20/227

(57) ABSTRACT

The present disclosure involves systems and methods for automatically analyzing available data exchange terms based on an analysis and comparison of available terms, where some of the terms may be unavailable in the current data exchange context based on the user and counter party to the data exchange. One example system includes a memory and a processor. Operations performed by the processor can include receiving a data exchange request associated with a set of information and an identifier. A set of contextual information associated with the received request can be determined. Options associated with the identifier, each associated with a set of terms, can be loaded from a storage device. A subset of viable options can be determined from the options based on the set of information and the contextual information, and a particular option from the subset can be selected for use in executing the received data exchange request.

### TECHNICAL FIELD

The present disclosure relates to computer systems, computer-implemented methods, and solutions for providing an analysis of available data exchange terms and conditions to be selected for a user based on an analysis and comparison of available terms and conditions, where some of the terms and conditions may be unavailable in the current data exchange context based on the user and counter party to the data exchange.

Current data exchange options are limited to providing a current set of approved data exchange options to a user for manual consideration and selection. Users must, in real-time, weigh complex transaction and contextual attributes to make their personal decision as to particular data exchange methodologies.

### SUMMARY

The present disclosure relates to computer systems, computer-implemented methods, and solutions for providing an analysis of available data exchange terms and conditions to be selected for a user based on an analysis and comparison of available terms and conditions, where some of the terms and conditions may be unavailable in the current data exchange context based on the user and counter party to the data exchange.

In one example system, the system may comprise a memory and at least one hardware processor interoperably coupled with the memory, where the at least one processor is configured to perform operations. The operations can include receiving a data exchange request, where the received data exchange request is associated with a set of information and an identifier. A set of contextual information associated with the received data exchange request can be determined. A set of options associated with the identifier can be loaded from a storage device, where each of the options is associated with a set of terms. A subset of viable options can be determined from the set of options based on the set of information and the contextual information, and a particular option from the subset of viable options can be selected for use in executing the received data exchange request.

In some instances, the data exchange request may comprise a transaction request, the set of information may comprise a set of transaction information, the identifier may comprise an account identifier, the set of options may comprise a set of potential payment options, the subset of viable options may comprise a subset of viable payment options, and the particular option may comprise a particular payment option.

In some of those instances, the operations may further include automatically generating a comparative analysis of the subset of viable payment options based on the set of transaction information, the set of contextual information, and the terms of the viable payment options.

In some of those instances, selecting the particular payment option from the subset of the viable payment options may include automatically, without user input, selecting the relatively higher ranked payment option from the subset of viable payment options.

In some of those instances, determining the set of contextual information associated with the received transaction request can include accessing information external to the transaction. In some instances, the set of contextual information can include data related to historical spending patterns of a user associated with the account identifier, wherein the data related to the historical spending patterns is used in the comparative analysis of the viable payment options. In some instances, the set of contextual information can include data associated with a calendar of a user associated with the account identifier, wherein the data associated with the calendar of the user is used in the comparative analysis of the viable payment options. In some instances, the set of contextual information can include a geographical location of a user associated with the account identifier at a transaction time identified in the set of transaction information or a geographical location of a provider associated with the transaction request at the transaction time identified in the set of transaction information. The geographic location may be included in the set of transaction information.

In some of those instances, the set of transaction information includes an amount of the transaction, one or more items included in the transaction, and two or more parties associated with the transaction.

In some of those instances, the set of terms associated with a particular payment option includes an annual percentage rate, a promotional annual percentage rate and the term of the promotional annual percentage rate, loyalty program information and restrictions, account restrictions, product account limits, and account balances.

In some of those instances, generating the comparative analysis includes generating a relative score to each of the subset of viable payment options. Further, selecting a particular payment option from the subset of viable payment options for use in settling the received transaction request can include identifying a user device associated with the account identifier, transmitting a request for selection of a particular payment option from at least a portion of the subset of viable payment options, wherein the request for selection includes the relative score associated with each of the payment options in the portion of the subset of viable payment options. An indication of a user selection of a particular payment is received in response to the transmitted request, and the particular payment selected by the user is selected to settle the received transaction request.

In some of those instances, the set of potential payment options associated with the account identifier can include a first potential payment option associated with a first financial institution and a second potential payment option associated with a second financial institution.

In some instances, determining the subset of viable payment options from the set of potential payment options based on the set of transaction information and the contextual information can include transmitting a subset of the transaction and contextual information associated with the transaction request to each financial institution associated with one of the potential payment options and receiving an indication of viability from the financial institutions for each potential payment option corresponding to that financial institution.

In some instances, the payment options can include a debit payment, a credit card payment, an installment loan, a charge card, a line of credit, a home equity line of credit, and a personal loan.

In some instances, the storage device can include a plurality of storage devices, where the plurality of storage devices are located remotely to the at least one processor, and wherein the plurality of storage devices are associated with at least one financial institution that is in turn associated with at least one of the set of potential payment options.

Similar or analogous computer-readable mediums storing non-transitory computer-readable instructions executable by a computer and configured to perform similar operations to the method may be used. Additionally, a computerized method performed by at least one processor can perform these or similar operations.

While generally described as computer-implemented software embodied on tangible and/or non-transitory media that processes and transforms the respective data, some or all of the aspects may be computer-implemented methods or further included in respective systems, non-transitory, computer-readable medium, or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for implementing an automatic determination of one or more particular available payment terms and conditions to be used in a transaction based on an analysis and comparison of options available to a user.

FIG. 2 is a swim-lane diagram illustrating example operations related to implementing and managing the automatic determination of payment terms and conditions to be used in one implementation of the described solutions.

FIG. 3 is a flowchart of example operations performed by a decision engine system in an example implementation, where the decision engine system automatically determines one or more payment terms and conditions to be used in response to a particular requested transaction.

FIG. 4 is a flowchart of example operations performed by a financial system, or alternatively, the decision engine system, for evaluating information related to a particular payment terms and conditions considered during the operations associated with example FIG. 3.

### DETAILED DESCRIPTION

The present disclosure describes systems and methods for providing an analysis of available payment instruments and options for a user based on an analysis and comparison of the available terms and conditions (also referred to as “payment options”) in response to a requested transaction. In particular, the described solution provides an automatic analysis that allows customers and users to maximize the benefit of particular available terms and conditions from a single credit location without having to consciously or actively choose the best option for a given transaction.

The concept of the present solution accepts the many consumer, businesses, and other entities have multiple accounts, multiple financial products, and multiple credit facilities from which funds may be available. Individuals involved in a particular transaction cannot generally engage in and make a holistically balanced review comparing each of their potential payment options to the particular transactional and contextual details related to the current purchase. The present solution automates this process by managing information related to a set of potential terms and conditions of various payment options associated with a single credit solution available to or associated with a particular customer. When the customer is associated with a transaction request, an automatic solution can be triggered where the transactional and contextual information are used to determine if various terms and conditions are available, and if so, determine which of those terms and conditions provide the optimal purchase and financing terms for the customer.

In one example, a customer may wish to purchase a new refrigerator at a big box appliance store. The customer can provide a unique identifier, such as an existing credit/debit card or a mobile payment identifier, for payment. One example of the described solution can identify the unique identifier as associated with a user registered with the solution, and can then access the potential terms and conditions associated with the registered user and the provided single credit solution. The solution can then determine which of those terms and conditions are available for use in this purchase (e.g., based on the counter party, the location of the purchase, current balances and upcoming payments, etc.), and then evaluate which of the available options provides the most advantageous terms in light of the user's historical usage and his or her current account balances, among others. Further, some options may include different optional terms (e.g., promotional interest rates, redeemable loyalty points, etc.) that can be evaluated and considered. In other words, the solution can manage a holistic view of multiple terms and conditions associated with one or more payment or credit types in light of user- and payment option-specific information.

In some instances, the payment instrument provided to the counter party may be a credit card, a debit card, a mobile payment identifier, an online payment login identifier, or others. The payment instrument can be registered to the advanced decision system such that the transaction request is forwarded to or intercepted by a middleware decision engine system. The decision engine system can calculate the particular terms and conditions to use for a particular transaction, in some instances including terms and conditions not necessarily associated with the payment instrument provided (e.g., user provides a credit card issued by Bank A, but the decision engine selects or recommends terms and conditions associated with a line of credit from a different Bank B). The decision engine system, upon determining the payment terms and conditions to use, can send the payment request to the financial institution or payment processor associated with the payment request such that the entity can settle the transaction through its secure channels.

In some instances, the decision engine system may provide ranking to the available potential payment options (i.e., different terms and conditions) during a comparative analysis, and can subsequently transmit a presentation of the options to a device or interface associated with the user, including any necessary or helpful details to assist in the decision. In response to receiving an indication of the user's selection, the decision engine system can proceed with the identified payment terms and conditions. Any suitable presentation of the available payment terms and conditions can be provided to the user, including suitable graphs or projections of the impact and costs associated with the particular choice.

In addition to a determination and comparison of available payment options, the decision engine system can consider user preferences and history. For example, a user may prefer to avoid using more than a certain threshold percentage of their available credit, or they may show a preference for particular credit cards or other rewards. The decision engine system, in addition to a raw comparison of the terms of the available payment options, can consider such user preferences in generating the evaluation and suggesting or using a particular payment option.

To perform the operations described herein, the present solution includes and uses a decision engine system that collects available payment option information from one or more financial institutions and matches the terms, conditions, and benefits of those options to the set of transaction and contextual information available to the system. In doing so, the decision engine system, which may be part of or associated with a particular financial institution or independent therefrom, can dynamically adjust execution of the requested transaction to a relatively better financial or payment terms and conditions for use in that single transaction. Each of the financial terms and conditions may be associated with one of several particular financial or payment product (e.g., credit cards, lines of credit, etc.), or they may be one of several options associated with a single financial or payment product (e.g., no payments/no interest for a period, a promotional interest rate, etc.). Further, and by extension, the decision system may be capable of analyzing individual line items in a larger transaction to individually associate different payment options with different items, item types, or groups of related items included in the requested transaction.

Another example is helpful in understanding the impact of the present solution. Joe, a consumer, has purchase habits that sees him making small transactions every day. Generally, Joe rarely purchases anything more than $50 in a given day, but does make 200-500 transactions a month that are below $20 from his debit card, divided between online and in-person transactions. Often times, Joe may go below his available balance to incur non-sufficient fund (NSF) fees, and will quickly increase the amount in the account into a minimal amount. Based on Joe's patterns of behavior and, for example, occasional non-standard small purchases, Joe goes in and out of a minimum balance status several times per month. In a current system, Joe would face significant transaction and NSF fees over time, particularly when unexpected higher priced purchase activity occurs.

The proposed system, however, will be able to detect Joe's usage patterns and can dynamically build terms, conditions, fee structures and general transaction boundaries which limit Joe's exposure to fees. The system can manage the optimal or relatively best terms and conditions of funds for each transaction dynamically based on contextual and real-time data, including Joe's historical usage patterns. For example, charges above the standard lower spending amount that he usually uses may be paid for by a credit account as opposed to the debit account. Therefore, Joe's customized financial product is in alignment with Joe's real-time spending patterns, context of the purchase, and financial situation.

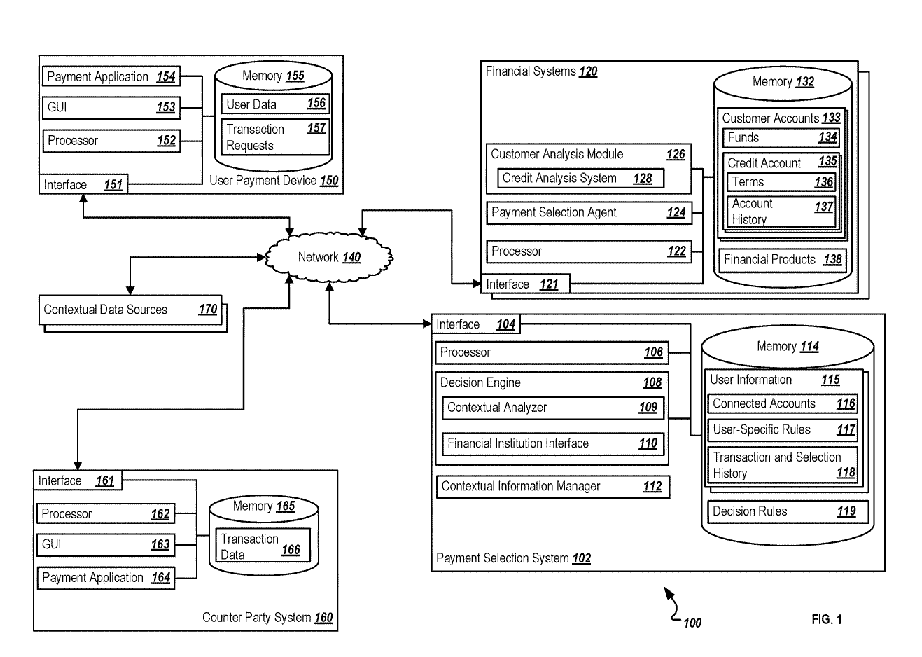

Turning to the illustrated embodiment, FIG. 1 is a block diagram illustrating an example system 100 implementing an automatic determination of one or more particular available payment terms and conditions to be used in a transaction based on an analysis and comparison of payment options available to a user. As illustrated in FIG. 1, system 100 is a client-server and device-client system capable of sharing transactional and connections information related to a transaction across various systems, where particular payment options are evaluated and compared to determine an optimal and/or relatively better payment option based on any number of suitable factors. Specifically, system 100 as illustrated includes or is communicably coupled with payment selection system 102, one or more financial systems 120, a user payment device 150, a counter party system 160, and others via network 140. Although components are shown individually, in some implementations, functionality of two or more components, systems, or servers may be provided by a single component, system, or server. Similarly, in some implementations, the functionality of one illustrated component, system, or server may be provided by multiple components, systems, servers, or combinations thereof. Conversely, multiple components may be combined into a single component, system, or server, where appropriate. In one implementation, for example, the payment selection system 102 may be a part of or included in the functionality of one or more financial systems 120, such that the operations performed by the payment selection system 102 are instead performed by a particular financial system 120.

As used in the present disclosure, the term “computer” is intended to encompass any suitable processing device. For example, the payment selection system 102 may be any computer or processing device such as, for example, a blade server, general-purpose personal computer (PC), Mac®, workstation, UNIX-based workstation, or any other suitable device. Moreover, although FIG. 1 illustrates a payment selection system 102, payment selection system 102 can be implemented using two or more systems, as well as computers other than servers, including a server pool. In other words, the present disclosure contemplates computers other than general purpose computers, as well as computers without conventional operating systems. Similarly, each of the financial systems 120 may be considered computers, as well as the user payment device 150 and the counter party system 160, among others. The computers may be of any type or form, including smartphones, tablets, laptop computers, desktop systems, smart watches, or any other suitable device. Further, illustrated financial system 120, user payment device 150, counter party system 160, and payment selection system 102 may each be adapted to execute any operating system, including Linux, UNIX, Windows, Mac OS®, Java™ Android™, or iOS. According to one implementation, the illustrated systems may also include or be communicably coupled with a communication server, an e-mail server, a web server, and/or other suitable server(s) or computer(s).

In general, the payment selection system 102 operates and is used to perform intelligent and automatic analyses or particular transactions in light of the transaction details, contextual information about and external to the specific transaction, and user-related information to determine which of two or more payment options available to particular users corresponding to transactions would be relatively more advantageous to use. The payment selection system 102 as illustrated in FIG. 1 contemplates a server system, although the payment selection system 102 may be represented as a cloud-based solution in other instances. The payment selection system 102 can perform many of the operations associated with it directly at the system 102, while in other instances, some, most, or all of the operations may be performed remotely. As illustrated, the payment selection system 102 may be a dedicated system associated with determining which payment options are to be used, although in other instances, the payment selection system 102 may be combined with one or more other components, including particular financial systems 120.

The payment selection system 102 includes various components for performing the comparative analysis of the various payment options. For example, the decision engine 108 can obtain, access, or otherwise identify financial and/or personal information associated with a particular user, while obtaining transactional information associated with a particular requested transaction. The payment selection system 102 can then perform the comparative analysis of the payment options and/or the various terms and conditions based on the transaction and transaction data, user preferences, and contextual information. In the current illustration, these operations (described below) are included within the functionality of the payment selection system 102 and its decision engine 108. In alternative implementations, the payment selection system 102 may be partially or completely performed by a separate component or device within system 100, without departing from the scope of the described solution. For example, one or more of the financial systems 120 may include a payment selection agent 124 as illustrated herein, and the user payment device 150 and/or the counter party system 160 may include payment applications 154, 164, respectively, which may or may not be associated with and/or a part of the payment selection system 102.

As illustrated, the payment selection system 102 includes an interface 104, a processor 106, a decision engine 108, a contextual information manager 112, and memory 114. In general, the payment selection system 102 is a simplified representation of one or more devices that allow for collection of transactional and contextual information associated with one or more transactions requested by users, where the payment selection system 102 uses that collected information along with information from financial systems 120 associated with various payment options available to the user to evaluate which of those payment options and/or terms and conditions provides a relatively better financial decision for the particular user. The payment selection system 102 may be a cloud-based system executing the payment selection and recommendation actions as a third party, or the payment selection system 102 may be associated with one or more financial institutions or existing financial systems 120. The payment selection system 102, through its functionality, can obtain information associated with a current transaction, identify user-specific accounts and user-specific preferences and tendencies, access current information associated those user-specific accounts, and then apply that information to identify one or more recommended or best payment options and/or terms and conditions for the user.

The interface 104 is used by the payment selection system 102 for communicating with other systems in a distributed environment—including within the environment 100—connected to the network 140, e.g., the user payment devices 150, the counter party systems 160, the contextual data sources 170, and the one or more financial systems 120, as well as any other systems communicably coupled to the network 140. Generally, the interface 104 comprises logic encoded in software and/or hardware in a suitable combination and operable to communicate with the network 140. More specifically, the interface 104 may comprise software supporting one or more communication protocols associated with communications such that the network 140 or interface's hardware is operable to communicate physical signals within and outside of the illustrated environment 100. Still further, the interface 104 may allow the payment selection system 102 to create ad hoc or dedicated connections to one or more available components.

Network 140 facilitates wireless or wireline communications between the components of the environment 100 (e.g., between the payment selection system 102, the financial systems 120, and the user payment device 150 and counter party systems 160, as well as between some or all of the other components illustrated in FIG. 1), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components (e.g., all or a portion of the payment selection system 102 itself) may be included within network 140 as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated, the payment selection system 102 includes a processor 106. Although illustrated as a single processor 106 in FIG. 1, two or more processors may be used according to particular needs, desires, or particular implementations of the environment 100. Each processor 106 may be a central processing unit (CPU), an application specific integrated circuit (ASIC), a field-programmable gate array (FPGA), or another suitable component. Generally, the processor 106 executes instructions and manipulates data to perform the operations of the payment selection system 102. Specifically, the processor 106 executes the algorithms and operations described in the illustrated figures, including the operations performing the functionality associated with the payment selection system 102 generally, as well as the various software modules (e.g., the decision engine 108 and the contextual information manager 112), including the functionality for sending communications to and receiving transmissions from the various components apart from the payment selection system 102.

The decision engine 108 acts as the evaluator of transactional information and contextual information associated with the transaction and the user in light of the current status of a particular user's accounts and preferences to determine one or more recommended or otherwise relatively better terms and conditions of any credit facility to be used for a particular transaction. The decision engine 108 represents an application, set of applications, software, software modules, or combination of software and hardware used to manage the payment selection system 102 and the operations associated with the payment terms and condition selection. In the present solution, the decision engine 108 can perform the described evaluations by accessing, obtaining, and interacting with one or more data sources providing current and/or real-time transactional data, context, account information, and available terms and conditions. The decision engine 108 may receive information relating to a particular transaction request from a user payment device 150, a counter party system 160, or a financial system 120. If one of the payment applications 154, 164 is associated with the payment selection system 102, the transaction request information may be received directly. In other instances, the transaction request may be initially routed to a particular financial system 120 associated with the payment selection system 102, where the financial system 120 can forward the transaction request to the payment selection system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others. The illustrated modules of the decision engine 108, as well as the other components of the payment selection system 102 (e.g., the contextual information manager 112) may be combined into a single application or module in some instances.

Upon receiving the transaction request, the decision engine 108 can identify a unique identifier associated with the transaction to identify a purchasing or buying user associated with the transaction request whose associated accounts and user profile are to be evaluated. The unique identifier may be a payment instrument identifier (e.g., a credit card number, a debit card number, a unique user identification or login information, or any other suitable identifier). In instances where the transaction request is received directly, the identifier may be included in the transaction data. If received from the financial institution, the unique identifier may be an identifier included in the transaction data, or the financial institution may substitute a non-card or payment instrument-related identifier for initiating the process. Once the unique identifier is received, the decision engine 108 can access user-specific information from the set of user information 115 in memory 114 (described below).

Turning to memory 114, memory 114 may include any memory or database module and may take the form of volatile or non-volatile memory including, without limitation, magnetic media, optical media, random access memory (RAM), read-only memory (ROM), removable media, or any other suitable local or remote memory component. The memory 114 may store various objects or data, including financial data, user information, administrative settings, password information, caches, applications, backup data, repositories storing business and/or dynamic information, and any other appropriate information including any parameters, variables, algorithms, instructions, rules, constraints, or references thereto associated with the purposes of the payment selection system 102. Additionally, the memory 114 may store any other appropriate data, such as VPN applications, firmware logs and policies, firewall policies, a security or access log, print or other reporting files, as well as others. For example, memory 114 can store the set of user information 115 and a set of decision rules 119 dictating one or more types and rules for various payment option and terms and conditions evaluations.

The set of user information 115 can include, among others, relevant information associated with particular users who have opted in or otherwise registered to use the payment selection system 102. The set of user information 115 can include a list of connected accounts 116 associated with a particular user, a set of user-specific rules 117 defining pre-defined or derived preferences of the particular user, and a transaction and selection history 118 of the particular user. The list of connected accounts 116 can identify particular payment options and/or terms and conditions associated with the particular user, as well as information on how financial systems 120 associated with those payment options can be contacted and accessed (e.g., a website or portal for accessing the information, relevant account numbers, user login or authorizing information for financial systems 120, etc.). The decision engine 108 and its financial system interface 110 can then be to actually access and obtain information associated with the identified payment options and user accounts. Based on that information and information related to the transaction, the context of the transaction request, and the user, the evaluation can be performed based on current information about the user's financial position and options.

The user-specific rules 117 may be a set of predefined options for users or a set of derived preferences based on actions and selections the user has previously made in different situations. For example, the user may specify a preference for a type of payment option, terms, and/or conditions to be used in certain situations, such as an airline or other rewards card. Another preference may specify limits to credit usage for particular cards to a percentage of a total available credit. Any number of user-defined restrictions or preferences may be defined, either at sign-up/registration for the service or during routine account management. In some instances, web- or app-based account maintenance may be available for such preferences to be defined by the user. In other instances, the payment selection system 102 may learn, based on user selections (e.g., after a recommendation of a particular payment option, a set of payment options, and/or particular terms and conditions), the preferences of a particular user. Based on those learnings, the payment selection system 102 can update and/or modify the user's preferences and rules to weigh those previous decisions. The transaction and selection history 118 may be an ongoing database or log of particular transactions and selections performed by the users, and may be used to determine one or more adjustments of the user-specific rules 117 for future evaluations. In some instances, the transaction history and the selection history may be maintained separately, either both at the payment selection system 102 or one or both at another location, including locally at the user payment device 150 or at one or more financial systems 120. The user-specific rules 117 may dictate modifications to a more general set of decision rules 119, where the decision rules 119 represent a baseline set of rules common to all users without user-specific considerations. The decision rules 119 may be applied until reasons or indications of changes to those rules are received, with those changes or revisions stored and made available for future processing in the user-specific rules 117.

As noted and using the unique identifier, the decision engine 108 can access the financial information associated with the user via the financial institution interface 110, which may be one or more interfaces capable of communicating with the financial systems 120 to access relevant financial information of the user using the connected account information 116. The decision engine's contextual analyzer 109 can take the transactional information, contextual information, and user information to evaluate the associated payment options and corresponding terms and conditions, and identify the best, or relatively better, payment option and particular terms and conditions to settle the transaction, or to recommend to the user to settle the transaction. The context analyzer 109 may be a contextual engine used to evaluate the information obtained by the decision engine 108 and provide insights and analysis based on the user's particular situation. The contextual analyzer 109 can consider both structured and unstructured data for a particular user to provide an understanding of the requested transaction and a reason or context for why the requested transaction has occurred. An example analysis of the contextual analyzer 109 can be in a situation where a user makes a purchase at a grocery store that, when compared to the history of the user, exceeds the normal spending for a week. The contextual analyzer 109 can use contextual information related to a user's calendar, where the calendar may include a particular event (e.g., a friend or relative's birthday). Based on this (simplified) analysis, the contextual analyzer 109 may determine that this particular event is at least a partial cause of the increased spending or transaction request. Using this contextual analysis and resulting knowledge, along with the understanding of the user's current financial situation as it relates to the potential payment options and/or terms and conditions, the decision engine 108 can provide a nuanced and comparative analysis of which option may be best suited for the user.

As illustrated, the payment selection system 102 includes a contextual information manager 112, where the contextual information manager 112 can identify, access, and/or obtain relevant contextual information from one or more sources, including the illustrated contextual data sources 170. The contextual information manager 112 may be connected to one or more social media, online, or personal/business accounts and/or profiles associated with a particular user. Some or all of those contextual data sources 170 may be registered by and/or made available by the user to the payment selection system 102, and can include a user's personal or business calendar (e.g., to identify pay dates, upcoming or current events potentially associated with a purchase, travel plans, etc.), social media accounts (e.g., Facebook, Twitter, etc.), and current user location information (e.g., available from GPS data provided by or associated with the user's mobile payment), among others. The contextual data sources 170 may include any suitable data source for data related to the transaction and/or the user, including physical sensors, online accounts, historical transaction logs and/or databases, and other suitable types of sources. In some instances, the contextual information manager 112 may obtain contextual information from one or more financial accounts linked to the payment selection system 102, such as information on recent and historical transactions performed using one or more payment options and/or terms and conditions, an expected number of transactions to be performed by the user and the expected amounts of those transactions based on historical usage, among others. The contextual information manager 112 may also consider and identify information that is not directly related to the user, but rather to similarly situated or otherwise comparable users. Information on decisions made by peer or cohort groups can be identified and used as part of the evaluation process for the current user. Social media servers and social media-related information can also be considered to assist in the evaluation of particular terms and conditions. In one instance, the particular user's social media accounts may be used to understand the context of the transaction, while in others, related or peer group's social media accounts and/or social media trends may be incorporated into the analysis.

The information collected by the contextual information manager 112 can be considered by the contextual analyzer 109 along with information provided in or associated with the requested transaction. For example, a transaction request may include information identifying a location of the counter party to the transaction, the types of items or services associated with the transaction, possibly including the particular items or services themselves, the total amount of the transaction, possibly including the amount associated with each item or service, and the type of account identifier provided to initiate the transaction (e.g., a particular credit card associated with the payment selection system 102, or a login to a payment processor such as PayPal, etc.). In some instances, this transaction information may be used to determine and/or provide additional weight to a particular set of terms and conditions. For example, if a user initiates a transaction at a retail store with a particular payment instrument, such as a card issued by the retail store, the rules may provide that absent a particular threshold level of advantage to using another card or payment terms and conditions, the particular payment instrument (that is, terms and conditions associated with the particular payment instrument) initially provided may be used or recommended. Similar considerations may be provided for any payment instrument provided, where recommendations of other payment terms and conditions are provided only when the advantage of another payment terms and conditions other than those associated with the payment instrument presented to initiate the transaction is significantly better. In those instances, the payment selection system 102 can allow the terms and conditions associated with the presented payment instrument to be used without interruption or request for a user's selection or confirmation.

Once the transaction and contextual information is obtained, the decision engine 108 can access the various accounts 116 associated with the current user. In some instances, one or more of the accounts 116 may not be eligible for use in a particular instance, such as where the counter party system 160 does not accept a particular form of payment (e.g., a first retailer does not accept a store credit account for a second retailer), or where particular user-specific rules 117 and/or decision rules 119 identify particular accounts as incompatible with a particular transaction.

The decision engine 108, via the financial institution interface 110 and/or interface 104, can access or request information from the various financial systems 120 defined in the connected accounts 116 for the particular user. Terms, conditions, and restrictions associated with payment options available to the associated user can be obtained by the payment selection system 102. In some instances, the payment selection system 102 may store and maintain the terms for the various accounts and payment options (i.e., terms and conditions of particular credit facilities) for future use, or the decision engine 108 can access the terms and restrictions for each transaction. In addition, the decision engine 108 can determine an overall existing account balance for the user at the particular financial system 120 (e.g., a cumulative amount for all payment options at the financial system 120), a particular payment option's account balance, restrictions on usage or types of transactions, any loyalty programs and restrictions/limitations associated with a particular payment option, and location-related restrictions or terms (e.g., foreign exchange fees, etc.) for particular payment options. In some instances, the decision engine 108 can communicate with an agent of the payment selection system 102 executing or available at the financial system 120, for example, the illustrated payment selection agent 124. In some instances, the determination of whether a particular payment option and the corresponding terms and conditions are available can be made at the financial system 120, based on whether funds or credit are available, whether the payment option and corresponding terms and conditions can be used in the requested transaction, or other considerations. In those instances, the financial system 120 can communicate that particular payment terms and conditions are not available to the payment selection system 102 and removing those terms and conditions from the available options.

Upon identifying the terms, conditions and status information for each of the potential options, the contextual analyzer 109 can use the collected sets of information to generate a relative ranking and comparative analysis of the available options. In some instances, the various available payment terms and conditions may be provided a relative or raw score or evaluation such that a ranking may be generated. In different implementations, and possibly based on user preference, the payment selection system 102 can either provide a presentation of at least a subset of the ranked payment terms and conditions to the user to allow for the user's ultimate selection of the available payment terms and conditions to apply, or an automatic selection of a particular payment terms and conditions can be made by the payment selection system 102. The automatic option may be explicitly authorized by the user in the user-specific rules 117. In some instances, the automatic selection may only occur where the relative ranking for the highest ranked option exceeds a predetermined or agreed amount. If the relative ranking for the highest ranked option does not exceed that amount, or where no automatic option is available or has been authorized, the decision engine 108 or another component or function of the payment selection system 102 can prepare and transmit the ranking of payment options and/or the terms and conditions to the user. The rankings may be provided at the user payment device 150, via another device or medium available to the user (e.g., text, email, popup notification, app-enabled event, etc.), via a point-of-sale system associated with the transaction, or through any other suitable channel. In some instances, upon automatic selection of a set of terms and conditions or in response to a user selection of a particular option, the payment selection system 102 can provide the financial system 120 associated with the selected terms and conditions and the transaction request for settlement. Settlement can be performed via the payment processing systems of the corresponding financial systems 120 or through payment processing capabilities available via the payment selection system 102 (not shown), which can provide or be associated with one or more existing payment rails or systems.

As described, one or more financial systems 120 can be associated with the analysis, where each financial system 120 is associated with one or more accounts and/or payment options as described. Illustrated financial system 120 is meant to be an example financial system 120, and can be associated with any suitable financial institution, person-to-person lending or payment application, or other suitable system. In some instances, the described solution may only be associated with a single financial institution, where that user has two or more financial products or payments options (i.e., different terms and conditions) available at the financial institution. In general, the financial systems 120 can communicate information associated with particular accounts 133 to the payment selection system 102, including fund balances 134, credit terms 136, and other relevant information.

The financial system 120 includes interface 121, processor 122, payment selection agent 124, customer analysis module 126, and memory 132. Interface 121 and processor 122 may be similar to or different from interface 104 and processors 106, respectively. Processor 106 executes the payment selection agent 124 and customer analysis module 126.

The payment selection agent 124 can provide several areas of functionality to the financial system 120 as it relates to the payment selection system 102. In some instances, the payment selection agent 124 can act as a listener for requested transactions that are received at a particular financial system 120, where the payment selection agent 124 can then forward or notify the payment selection system 102 of the transaction request and any related details thereof. In this sense, the payment selection system 102 can be accessed without a direct communication from the user payment device 150 or the counter party system 160 to the payment selection system 102, allowing the financial systems 120 to initially trigger the evaluation. The payment selection agent 124 may be located at any point along the rails of a transaction request and prior to settlement, including at a payment processor or other suitable location. The payment selection agent 124 can also be used as an entry point for the payment selection system 102 into the corresponding financial system 120, where requests for particular sets of information for a user are sent via the payment selection agent 124, which may be able to use the other components and functionality of the financial system 120 to access the requested information needed for the payment option/terms and conditions-based comparison. The payment selection agent 124 may be integral to the financial system 120, or the agent 124 may be a specific piece of software or processes executing thereon. The payment selection agent 124 may be any suitable application, module, process, application programming interface (API), daemon, or listener, among others.

The customer analysis module 126 may be software capable of accessing customer account information for the financial institution, and may be an existing or newly created application or module. The customer analysis module 126 can access customer account 133 information for the financial systems 120, and, in the illustrated example, the functionality associated therewith can be used by the payment selection agent 124 to obtain user-specific information from the financial system 120. The customer analysis module 126 can obtain information from the customer accounts 133 stored in memory 132, which may be similar to or different than memory 114. The customer accounts 133 may include information on the user's available funds 134 and one or more credit accounts 135. Funds 134 may represent cash and/or debit accounts, while the credit accounts 135 may include credit-based accounts and other credit facilities (e.g., credit cards, lines of credit, home equity lines of credit). The credit account 135 information may include current credit balances, credit limits, and other relevant information. The credit account 135 information may include information on credit terms 136, including specialized terms associated with different purchase types, loyalty and reward information, promotional balance offers, and other information related to the actual usage of credit, including rules for the usage of the credit and any promotions or limitations. As each credit account's terms (and conditions) 136 may differ based on the particular context of a transaction, the details of such terms 136 can be used in the evaluation described herein to determine whether or not a particular payment option (and its corresponding terms and conditions, including instances where a particular payment option is associated with multiple terms and conditions options) is relatively better than others. Each credit account 135 may also be associated with historical account data 137, which can be used to provide insights as to prior usage of the credit account 135. The cash-based funds 134 may also include account history information, although such information is not illustrated herein. The historical account information 137 can be used to identify expected activity in the account, while also potentially providing information on scheduled activity for the near or recurring future. The customer analysis module 126 can use this information to identify whether a particular payment option and/or particular sets of terms and conditions of that financial system 120 is available for the current transaction request, as well as provide information to the decision engine 108 to assist in making the comparative analysis.

In some instances, the customer analysis module 126 may determine that the existing funds 134 and/or credit accounts 135 are incapable of funding a requested transaction. In those instances, the financial system 120 may use a credit analysis system 128 to determine whether an increase in the user's credit lines can and should be made, as well as whether an additional credit account or facility should be opened or made available to the user. Such determinations may be made during the evaluation process, where the credit analysis system 128 and the financial system's functionality can automatically increase or modify the available credit accounts 135 of the user, including identifying one or more financial products 138 to offer the user should additional facilities be allowed. In some instances, a determination that the existing funds 134 and/or credit accounts 135 are unable to fund a transaction may be based on a review of the account histories 137 of the user. For example, if the user has $6000 in funds available in a checking account at the time of the evaluation, but the history 137 shows that a $4000 mortgage is paid every month out of the account shortly after the transaction is requested, the customer analysis module 126 may determine and return that the particular funds 134 are insufficient. Similar analyses can be made for any accounts, where appropriate. In some instances, the customer analysis module 126 may include a warning or notice of a future or upcoming activity associated with a particular account to the decision engine 108, allowing the account to be used, if necessary, but also providing the decision engine 108 with sufficient information to be considered by the contextual analyzer 109.

The illustrated environment 100 includes a user payment device 150 associated with a user-initiated transaction request. The user payment device 150 may be any suitable computing device operable to initiate a transaction request associated with a purchase or other requested transaction. The user payment device 150 is connected to the financial systems 120 and payment selection system 102 via network 140, wherein information related to a particular transaction can be communicated at the time of the request. Each user payment device 150 may be or include a desktop computer, a mobile device, a tablet, a server, or any other suitable computer device. In general, user payment device 150 comprises an electronic computer device operable to receive, transmit, process, and store any appropriate data associated with the environment 100 of FIG. 1. In particular, user payment device 150 executes one or more payment applications 154 from which one or more transactions are requested, and in some instances, where a set of potential payment options and/or terms and conditions are provided by the payment selection system 102 for user confirmation and/or selection.

As illustrated, user payment device 150 includes an interface 151, a processor 152, a graphical user interface (GUI) 153, a payment application 154, and memory 155. The interface 151 and processor 152 may be similar to or different than the interfaces 104, 121 and processors 106, 122 described for the payment selection system 102 and financial systems 120, respectfully. The components of the user payment device 150 can be designed for the particular device's particular type of computing device. In general, processor 152 executes instructions and manipulates data to perform the operations of the user payment device 150. Specifically, the processor 152 executes the algorithms and operations described in the illustrated figures, including the operations performing the functionality associated with the payment application 154. Memory 155 may be similar to or different than memories 114, 132. As described, memory 155 includes user data 156 and generated transaction requests 157 as described below.

User payment device 150 executes the payment application 154 operable to perform any suitable functionality, including but not limited to, generating transaction requests, capturing contextual information available at the user payment device 150, providing the transaction requests and contextual information to the payment selection system 102, and, in some instances, managing the selection of a particular payment option and/or terms and conditions from a set of recommended payment options and/or terms and conditions provided by the payment selection system 102. Payment application 154 may be a web application, desktop application, portal page or portal-based application or process, a dedicated mobile application, or other software. The payment application 154 may generate one or more transaction requests, and can be associated with one or more particular financial systems 120 (e.g., a particular financial institution), or the payment application 154 may be a third party application, either of which may consider payment options (i.e., available terms and conditions of credit facilities) of the user associated with a single financial institution or with multiple financial institutions, where the multiple financial institutions are each associated with one or more terms and conditions options for the user. The user data 156 may be used to generate the transaction requests 157, or to provide contextual data associated with a particular transaction. The contextual information may include data located on the device 150 and as allowed by the user, such as user calendar information, text, email and other communications, and user location information, among others. In some instances, the payment application 154 can include such contextual information into the generated transaction request 157, or the information can be attached as a separate file or metadata associated with the transaction request 157. The payment application 154 may cause the transaction request 157 to be delivered to any suitable location along a payment processing route, including directly to the payment selection system 102 or to a particular financial system 120, where the transaction request 157 is then forwarded or otherwise delivered, in part or in whole, to the payment selection system 102 for evaluation. Once the evaluation is complete, in situations where user input and selection is required, the payment application 154 can present the terms and conditions options and receive user input identifying a particular option to be used.

GUI 153 of the user payment device 160 may be a graphical user interface (GUI) of the user payment device 150. The GUI 153 interfaces with at least a portion of the environment 100 for any suitable purpose, including generating a visual representation of a web browser and/or the payment application 154. In particular, the GUI 153 may be used to view and navigate various web pages or applications and device functionality located both internally and externally to environment 100, as well as to view and navigate through information accessed by the payment application 154, such as information stored at or associated with the financial systems 120 and/or the payment selection system 102, as well as to interact with the counter party system 160, where appropriate. Generally, the GUI 153 provides the particular user with an efficient and user-friendly presentation of data provided by or communicated within the system. The GUI 153 may comprise a plurality of customizable frames or views having interactive fields, pull-down lists, and buttons operated by the user. For example, the GUI 153 may provide interactive elements that allow a user to initiate a transaction request or view or interact with the one or more options provided by the payment selection system 102. In general, the GUI 153 is often configurable, supports a combination of tables and graphs (bar, line, pie, status dials, etc.), and is able to allow users to modify instructions, parameters, and settings associated with the payment application 154. Therefore, the GUI 153 contemplates any suitable graphical user interface, such as a combination of a generic web browser, intelligent engine, and command line interface (CLI) that processes information in the platform and efficiently presents the results to the user visually.

In some instances, an implementation of the present solution may occur without a user payment device 150, where the user can initiate transactions with a traditional payment instrument (e.g., credit/debit card) via a counter party system 160. In those instances, the counter party system 160 may generate the transaction request to initiate the processes described herein. In those instances, where additional user input is needed to determine the particular option to be used, the options can be provided to another device or channel associated with the user (e.g., a mobile phone notification and app, an email, a text), where the user can make the selection through that device or channel. In some instances, the counter party system 160, such as a point-of-sale system or interface device provided by the counter party, may present the relevant options to the user. Alternatively, the user payment device 150 may interact with the counter party system 160 to obtain information related to a particular purchase, including contextual information, at the time of the transaction, where the user payment device 150 generates the transaction request. Information related to subsequent transactions being performed, including settlement of the transaction, can be provided to the counter party system 160 for completing the transaction.

As illustrated, the counter party system 160 includes an interface 161, a processor 162, a GUI 163, a payment application 164, and memory 165. In some instances, the counter party system 160 and the user payment device 150 may be similar devices, where the differences between the devices are only in the parties to the transactions (e.g., a buyer and a seller, where the two parties change in different transactions). The interface 161, processor 162, GUI 163, and memory 165 may be similar to or different than the interface 151, processor 152, GUI 153, and memory 155 of the user payment device 150. Likewise, the payment application 164 may be similar to the payment application 154, performing similar or different functionality to assist in the payment selection process. Memory 165 includes transaction data 166, which may be contextual or transaction data available from or generated by the counter party system 160 at the time of the transaction, including the items being transacted, their pricing, the location of the counter party, and/or any other suitable information. While not illustrated here, additional data may be available from the counter party system 160, including information identifying the counter party, providing one or more restrictions of payment types accepted by the counter party, and any other suitable information for use in the evaluation.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

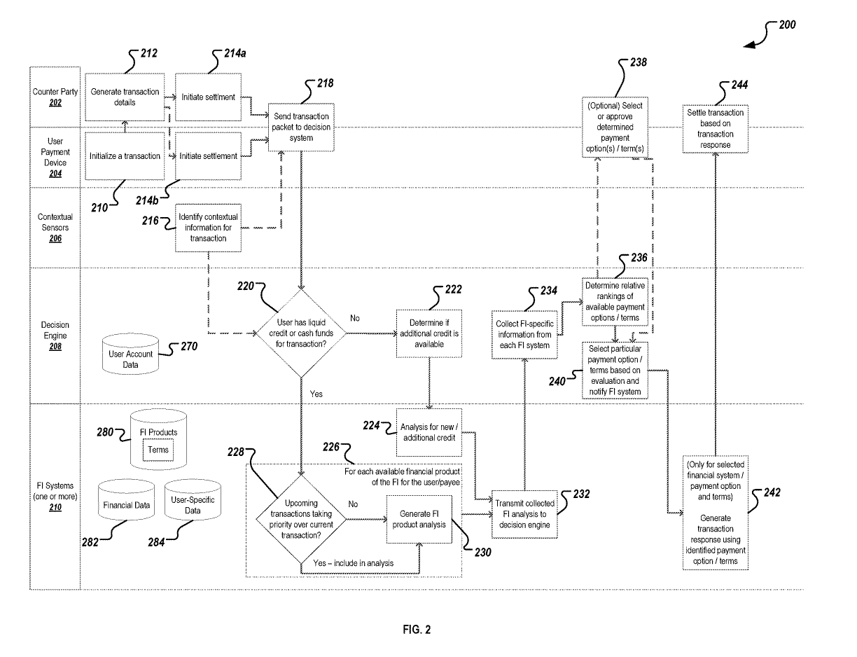

FIG. 2 is a swim-lane diagram illustrating example operations related to implementing and managing the automatic determination of terms and conditions options to be used in one implementation of the described solutions. For clarity of presentation, the description that follows generally describes method 200 in the context of the system 100 illustrated in FIG. 1. However, it will be understood that method 200 may be performed, for example, by any other suitable system, environment, software, and hardware, or a combination of systems, environments, software, and hardware as appropriate.

FIG. 2 describes an example set of operations across five components, a counter party 202, a user payment device 204, one or more contextual sensors or systems 206, a decision engine 208, and one or more financial systems 210. In some instances, the decision engine 208 may be a part of a particular financial system 210, such that requests sent to the decision engine 208 are sent to a particular financial system 210. Although described in a particular layer, some of the operations may occur at a different layer in particular implementations. Alternatively, some of the operations may occur at multiple layers in other implementations, such that an illustrated operation occurs in multiple steps or actions at two or more layers. For example, different implementations may allow a user payment device 204 or a counter party system 202 to initiate or initialize a transaction. In the illustrated example of FIG. 2, the user payment device 204 initializes the transaction at 210. However, in other instances, the counter party 202 may initialize the transaction.

At 212, the counter party 202 may generate transaction details related to the transaction, including information about the particular items being transacted, including the item description, an item type, an item-specific price for each item, and an overall cost associated with the transaction. Additional details may also be included about the transaction, including some contextual information. Further, although FIG. 2 describes the counter party system 202 as generating the transaction details, some or all of the transaction details may also be generated by the user payment device 204, where appropriate, including by adding user contextual information available at the device 204.

At 214 (214a or 214b), the settlement process is initiated. As illustrated, the settlement process can be initiated by either the counter party system 202 or the user payment device 204 depending on the particular implementation. In doing so, a requested transaction package or packet can be generated, where the package includes transactional details associated with the transaction and, in some instances, additional contextual information. The contextual information may be included in the package or provided along with the package, allowing the contextual information to be separated from the transactional details for privacy purposes, where appropriate. At 218, either of the counter party system 202 or the user payment device system 204 may send the transaction packet to a receiving system, such as the decision engine 208. In some implementations, the transaction packet may be sent initially to a particular financial system 210 instead of the decision engine 208. The financial system 210 can determine that the user or customer associated with the requested transaction is registered or otherwise associated with the decision engine 208 and its functionality, and can intercept and forward such transaction requests to the decision engine 208 for further evaluation of payment options and particular sets of terms and conditions. As described in FIG. 1, the decision engine 208 may have an agent or other process executing at the financial system(s) 210 to identify when such requests are received.

As illustrated, the contextual sensors 206 may capture or make available additional contextual information outside of the transaction itself at 216. In some instances the contextual sensors 206 may provide such information to the user payment device 204 or the counter party system 202 prior to the transaction packet being sent, or any additional contextual information may be provided to the decision engine 208 for further consideration during the evaluation process.

At 220, the decision engine 208 (or alternatively, one or more of the financial systems 210) can determine whether a user has liquid credit or cash funds to perform or fulfill the requested transaction. In some instances, such a determination can be based on general account status information maintained by the decision engine 208 about different user accounts, or by a quick calculation or accessing of available funds and credit lines identified by corresponding with or accessing the financial systems 210 and their account statuses. The particular funds and credit accounts associated with a particular user can be stored in the set of user account data 270, which can be managed at or accessible by the decision engine 208. If a determination is made that current funds and/or credit accounts cannot cover the requested transaction, method 200 can continue at 222, where the decision engine 208 can determine whether additional credit is available to the user. In such instances, the decision engine 208 or another suitable component can query one or more of the financial systems 210 and have them, at 224, perform an analysis as to whether additional credit facilities or increased credit lines are available. Such determinations can then be collected at 232 in a financial system analysis and transmitted back to the decision engine 208 for further evaluation. The analysis at the financial systems 210 for additional credit may include an analysis of the user's financial data 282, user-specific information 284, and the available financial products 280 of the financial system 210. Any suitable credit worthiness determination can be used to determine if additional credit should be provided.

Where, however, the user is determined to have adequate liquid credit and/or cash funds to cover the transaction, the decision engine 208 can request financial system 210 analyses to be performed to obtain additional information about the potential payment options and terms and conditions associated with each of the financial systems 210. As noted, the financial systems 210 to be accessed or from which information is to be requested can be defined by the user account data 270, where the particular systems 210 and potentially, the various payment options and/or terms and conditions of each system 210, are provided and registered.

At 226, a process for determining whether each payment option and/or terms and conditions of a particular financial system 210 is available is performed, as well as a collection of information related to the particular payment option or product. At 228, a determination is made as to whether any upcoming transactions take priority over the current transaction. This determination can be based on already scheduled transactions (e.g., a scheduled payment), a recurring charge based on prior account activity (e.g., a large monthly expense, such as a car or home payment), or any other suitable information. Whether such transactions are identified can be included in a generated payment option analysis at 230. Each analysis is for a particular payment option and its associated terms and conditions, and can be performed for each of the potential payment options (and corresponding sets of terms and conditions) associated with a particular financial system 210. The analysis can include information on the user's account associated with the particular payment option, the available sets or available terms associated with payment option or product (e.g., interest rates, promotional financing, loyalty information, etc.), of which multiple sets of terms and conditions may be associated. After the analysis is performed for each of the payment options and the particular sets of terms and conditions associated therewith, the financial system 210 can transmit the collected financial system payment option analysis to the decision engine 208 at 232, where the decision engine 208 can use the information to perform the comparative evaluation of all available payment options and corresponding terms and conditions. In some instances, the various payment option analyses can be sent to the decision engine 208 as they are completed as opposed to a single communication.

At 234, the decision engine 208 can collect the results of each payment option analysis performed by the one or more financial systems 210, including the current status of the various accounts associated with the payment options and the terms available for each payment option, where some options are associated with multiple distinct sets of terms and conditions. At 236, the decision engine 208 can perform a detailed analysis based on the transaction information, contextual information, and payment option information collected to identify and rank the one or more available payment options and/or terms and conditions. Depending on the specific user and implementation, including user preferences for operation of the system, the decision engine 208 may be capable of automatically determining the payment option and/or particular terms to be applied for settling the transaction. In such instances, the relatively highest ranked available payment option (and/or terms) can be identified at 240 and selected as the payment option (and/or terms) to be used. Alternatively, the decision engine 208 can prepare a subset of relatively higher ranked payment options (and/or terms) for presentation to the user after the ranking, and can request user input as to which of the payment options and/or terms to use. In some instances, this may be a confirmation request asking the user to confirm using the relatively highest ranked option, while in others, the user may be asked to select a particular option from the subset. The user may be sent, via any suitable channel, the subset of options and the request for selection. In some instances, the presentation may be made at the user payment device 204 or the counter party system 202, while in other instances, the presentation may be made via a separate device or channel. For example, the transaction request may be initiated in one example at a point-of-sale associated with the counter party system 202. However, the presentation may be provided via a text or messaging interaction or from an app-based interaction with a related payment application executing at the user's mobile device. In response to the user's selection of a particular option at 238 (illustrated at either the counter party system 202 or the user payment device 204, although alternative devices may perform the selection), the particular option can be selected by the decision engine 208. Along with the selection, the financial system 210 associated with the selected option can be notified, where that particular financial system 210 can generate a transaction response using the selected option and its particular terms and conditions at 242. The generated transaction response can then be provided to the initiated system (either the user payment device 204 or the counter party system 202) to settle the transaction based on the transaction response at 244.

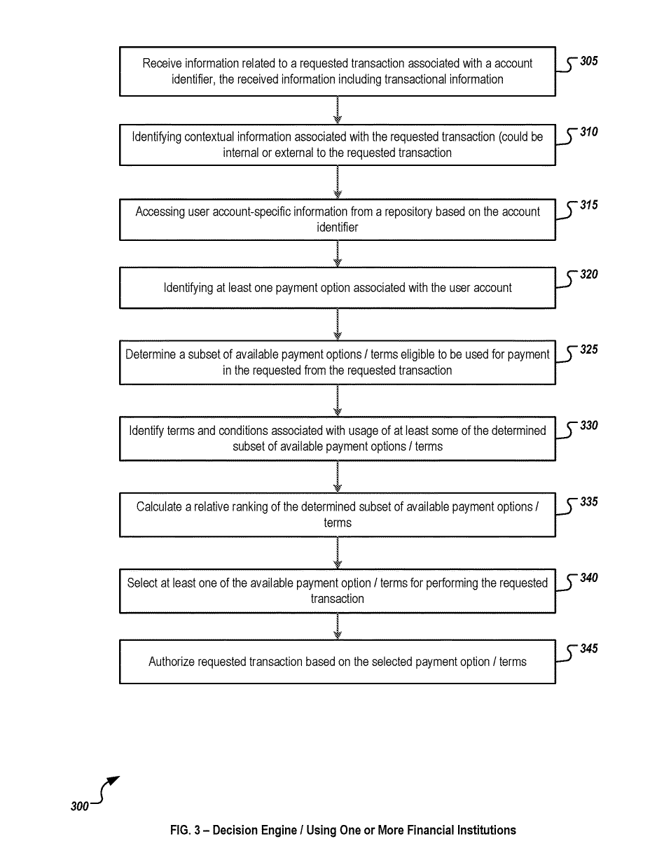

FIG. 3 is a flowchart of example operations 300 performed by a decision engine system in an example implementation, where the decision engine system automatically determines one or more payment terms and conditions to be used in response to a particular requested transaction. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, information related to a requested transaction associated with an account identifier is received, where the received information includes at least transaction information defining transaction information to be used in the analysis. This information may include, but is not limited to, an indication of the party or parties to the transaction, the items or services being transacted, and the individual and/or cumulative costs of the items or services. The account identifier included in the transactional information can be used to identify or determine a particular user associated with the transaction, such as a credit card number, a debit card number, a driver's license number, a checking account number, a web- or app-based user identifier and authorization information, or any other suitable identifier. In some instances, the account identifier may be associated with a particular payment type or account, where in other instances, the account identifier merely identifies the user associated with the transaction without a specific option identified. The information can be received from a point-of-sale associated with a counter party system, an application associated with a user payment device, or any other suitable origin or relay.

At 310, contextual information associated with the requested transaction is identified. The contextual information may be internal or external to the requested transaction. For example, the contextual information may include a location of the transaction included or associated with the requested transaction, a time of the transaction, or other information specific to the transaction itself. Additionally, the contextual information can include user-specific information or data associated with the user, and not the transaction, such as user calendar information, recent social media activity, other recent transactions within a certain period of time, transaction frequency of similar transactions, other historical spending or transaction information, and other suitable data. Still further, the contextual information can be information not about the user or the transaction, but rather contextual information about other users similar to the user, such as demographically or economic status.

At 315, user account-specific information associated with the account identifier can be accessed from a repository associated with the decision engine system, where the account-specific information identifies the user associated with the account identifier. At 320, at least one payment option associated with at least one set of terms and conditions associated with the user in the repository can be identified, where the payment options may be associated with one or more financial systems. In some instances, the current solution may be limited to payment options associated with a single financial institution. In others, the payment options (and thus, available terms and conditions) may be associated with two or more different financial systems or institutions. In some instances, the account information may include snapshot information associated with the one or more financial systems, payment options, and current terms and conditions, including current balances, credit limits (where applicable), and other basic information. In other instances, the account information may identify how the decision engine system or a related component can access those identified financial systems to determine the real-time or current status of those accounts.

At 325, a determination is made to identify a subset of the options that are available for use with the current transaction. In some instances, the determination can be made based on current balances associated with the different options, knowledge of or information related to upcoming and expected transactions and how those transactions may affect usage of the payment option for the requested transactions, limitations related to the usage of a particular option (e.g., a store-specific charge card cannot be used away from that store), and user preferences for particular options or overall credit and fund usage preferences. Based on the determination, a subset of the options associated with the user's account may be left as potential options for settlement of the requested transaction.

At 330, the sets of terms and conditions associated with the usage of the determined subset of available payment options can be identified. In some instances, those terms and conditions, as well as status information associated with the account, can be obtained from the financial systems associated with the payment options. Payment options may be associated with distinct sets of terms and conditions, including but not limited to standard rates for normal purchases, promotional rates for different types of transactions or for transactions associated with particular goods or services, different repayment and interest-free periods, and other varying terms and conditions. In some instances, the decision engine system may store or otherwise have available some current information related to the various payment options and their associated terms and conditions, such that accessing the information at the financial systems may not be necessary in each instance.

At 335, the decision engine system, using a combination of the transaction information, the contextual information, and the terms and status of the various options, can calculate and determine a relative ranking of the determined subset of available options. In some instances, each option from the subset may be associated with a raw or relative score, allowing the decision engine system to rank the available options based on the considered factors. Use of the contextual information may significantly affect the ranking of the particular terms and conditions from among the available options. For example, as noted the contextual information may include an indication of the location of the requested transaction. Based on particular a first set of terms and conditions, a significant foreign transaction fee may be assessed on a transaction along with a 5% interest rate, while a second set of terms and conditions may include no transaction fee and a 10% interest rate. The decision engine system can compare the amount of the transaction, the location of the transaction, and relative fees and costs associated with the two sets of terms and conditions to generate a ranking between the two sets. Based on the comparison, a ranked set of payment options between those two sets of terms and conditions can be generated. Similar analyses can be performed using any of the contextual information obtained during the process along with historical and current account information, including historical spending and payoff behavior, likely future behavior, the size of a particular transaction, loyalty programs available for particular products under the various sets of terms and conditions, as well as other criteria and considerations.

At 340, at least one of the available ranked options' terms and conditions is selected for performing the requested transaction. In some instances, two or more of the options' terms and conditions are provided to the user for manual selection of the particular payment terms and conditions to be used by the system, while in other instances, a confirmation request may be sent to the user to confirm usage of a particular payment terms and conditions. Upon selection or confirmation by the user, the selected or confirmed payment terms and conditions are used. In other instances, the decision engine system may be authorized to automatically enact settlement of the transaction based on the relatively highest ranked payment terms and conditions without the need for further user input or action.

At 345, the decision engine system can confirm and authorize the requested transaction based on the selected option's terms and conditions. In some instances, the decision engine system can provide a notification of the transaction request to the financial system associated with the selected payment terms and conditions, wherein that financial system can then perform the operations needed using the selected payment terms and conditions to settle the transaction.

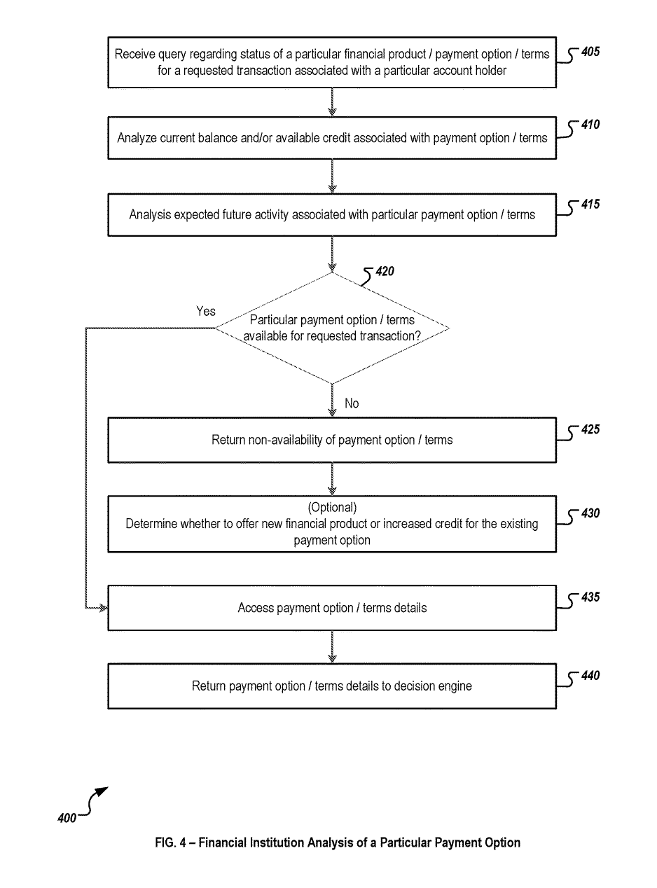

FIG. 4 is a flowchart of example operations 400 performed by a financial system or, alternatively, the decision engine system, for evaluating information related to particular payment terms and conditions considered during the operations associated with example FIG. 3. For clarity of presentation, the description that follows generally describes method 400 in the context of the system 100 illustrated in FIG. 1 and method 300 of FIG. 3. However, it will be understood that method 400 may be performed, for example, by any other suitable system, environment, software, and hardware, or a combination of systems, environments, software, and hardware as appropriate.

At 405, a query related to the status of a particular payment option, particular terms and conditions associated with a particular payment option, or financial product associated with a particular account holder is received. The query may be based on the identification, by the decision engine system, of potential payment options (i.e., terms and conditions) associated with a user. The query is meant to initially identify whether or not a particular payment option and/or a set of terms and conditions are available based on transaction details and information. At 410, a current balance and/or available credit associated with a particular account (i.e., the payment option), is analyzed. If the current balance or available credit is sufficient for the requested transaction, an analysis of expected future activity associated with the account can be determined at 415 (e.g., if an upcoming scheduled or potential event would reduce the balance or available credit such that the payment option cannot be used). At 420, a determination is made as to whether the particular financial product, payment option, and/or terms and conditions are available to be used in the requested transaction. The determination may be no if the current balance/credit available is insufficient for the transaction amount, or if an expected future activity would render the payment option to be unable to fulfill the expected activity or the requested transaction. In some instances, multiple distinct sets of terms and conditions may be associated with a particular payment option, where only some of the sets of terms and conditions are available in a particular situation. For example, one set of terms and conditions may be based on an amount financed, such that a particular purchase or transaction fails to reach the minimum required amount. However, another set of terms and conditions may be available for the current transaction. If the payment option and at least some of its terms and conditions are available, method 400 continues at 435. If the payment option is determined not to be available, method 400 moves to 425, where a notification of the non-availability of the payment option (or particular terms and conditions) can be provided to the decision engine system. Optionally, a determination may be made at 430, even in light of the relative non-availability of the payment option, to offer a new financial product to the user for use in the requested transaction or an increase to an existing payment option's credit availability or limits. If additional credit is available and offered, method 400 can move from 430 to 435.

At 435, the option's financial product details can be accessed, including the option's terms and conditions (e.g., one more sets of available terms and conditions). This information can be collected and returned to the decision engine system at 440 for comparison against the other available payment options' terms and conditions and a determination of a relatively best or better payment terms and conditions as described in FIG. 3.

The preceding figures and accompanying description illustrate example systems, processes, and computer-implementable techniques. While the illustrated systems and processes contemplate using, implementing, or executing any suitable technique for performing these and other tasks, it will be understood that these systems and processes are for illustration purposes only and that the described or similar techniques may be performed at any appropriate time, including concurrently, individually, or in combination, or performed by alternative components or systems. In addition, many of the operations in these processes may take place simultaneously, concurrently, and/or in different orders than as shown. Moreover, the illustrated systems may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system comprising:
a memory storing instructions;
at least one hardware processor interoperably coupled with the memory, wherein the instructions instruct the at least one hardware processor to:
receive a data exchange request, the received data exchange request associated with a set of information, the data exchange request associated with an identifier;
determine a set of contextual information associated with the received data exchange request;
load, from a storage device, a set of options associated with the identifier, each of the options associated with a set of terms;
determine a subset of viable options from the set of options based on the set of information and the contextual information; and
select a particular option from the subset of viable options for use in executing the received data exchange request.

2. The system of claim 1, wherein the data exchange request comprises a transaction request, the set of information comprises a set of transaction information, the identifier comprises an account identifier, the set of options comprises a set of potential payment options, the subset of viable options comprises a subset of viable payment options, and the particular option comprises a particular payment option.

3. The system of claim 2, the instructions further instructing the at least one hardware processor to automatically generate a comparative analysis of the subset of viable payment options based on the set of transaction information, the set of contextual information, and the terms of the viable payment options.

4. The system of claim 2, wherein selecting the particular payment option from the subset of the viable payment options comprises automatically, without user input, selecting the relatively higher ranked payment option from the subset of viable payment options.

5. The system of claim 2, wherein determining the set of contextual information associated with the received transaction request includes accessing information external to the transaction.

6. The system of claim 2, wherein the set of contextual information includes data related to historical spending patterns of a user associated with the account identifier, wherein the data related to the historical spending patterns is used in the comparative analysis of the viable payment options.

7. The system of claim 2, wherein the set of contextual information includes data associated with a calendar of a user associated with the account identifier, wherein the data associated with the calendar of the user is used in the comparative analysis of the viable payment options.

8. The system of claim 2, wherein the set of contextual information includes a geographical location of a user associated with the account identifier at a transaction time identified in the set of transaction information or a geographical location of a provider associated with the transaction request at the transaction time identified in the set of transaction information.

9. The system of claim 8, wherein the geographic location is included in the set of transaction information.

10. The system of claim 2, wherein the set of transaction information includes an amount of the transaction, one or more items included in the transaction, and two or more parties associated with the transaction.

11. The system of claim 2, wherein the set of terms associated with a particular payment option includes an annual percentage rate, a promotional annual percentage rate and the term of the promotional annual percentage rate, loyalty program information and restrictions, account restrictions, product account limits, and account balances.

12. The system of claim 2, wherein the generating the comparative analysis comprises generating a relative score to each of the subset of viable payment options, and wherein selecting a particular payment option from the subset of viable payment options for use in settling the received transaction request comprises:
identifying a user device associated with the account identifier;
transmitting a request for selection of a particular payment option from at least a portion of the subset of viable payment options, wherein the request for selection includes the relative score associated with each of the payment options in the portion of the subset of viable payment options;
receiving, in response to the transmitted request, an indication of a user selection of a particular payment; and
selecting the particular payment selected by the user to settle the received transaction request.

13. The system of claim 2, wherein the set of potential payment options associated with the account identifier include a first potential payment option associated with a first financial institution and a second potential payment option associated with a second financial institution.

14. The system of claim 2, wherein determining the subset of viable payment options from the set of potential payment options based on the set of transaction information and the contextual information comprises:
transmitting a subset of the transaction and contextual information associated with the transaction request to each financial institution associated with one of the potential payment options;
receiving an indication of viability from the financial institutions for each potential payment option corresponding to that financial institution.

15. The system of claim 2, where the payments options include a debit payment, a credit card payment, an installment loan, a charge card, a line of credit, a home equity line of credit, and a personal loan.

16. The system of claim 2, wherein the storage device includes a plurality of storage devices, the plurality of storage devices located remotely to the at least one processor, the plurality of storage devices associated with at least one financial institution associated with at least one of the set of potential payment options.

17. A computerized method performed by one or more processors, the method comprising:
receiving a transaction request, the received transaction request associated with a set of transaction information, the transaction request associated with an account identifier;
determining a set of contextual information associated with the received transaction request;
identifying, from a repository, a set of potential payment options associated with the account identifier, each of the payment options associated with a set of terms;
determining a subset of viable payment options from the set of potential payment options based on the set of transaction information and the contextual information;
automatically generating a comparative analysis of the subset of viable payment options based on the set of transaction information, the set of contextual information, and the terms of the viable payment options; and
selecting a particular payment option from the subset of viable payment options for use in settling the received transaction request.

18. The method of claim 17, wherein selecting the particular payment option from the subset of the viable payment options comprises automatically, without user input, selecting the relatively higher ranked payment option from the subset of viable payment options.

19. The method of claim 17, wherein the set of contextual information includes at least one of:
data related to historical spending patterns of a user associated with the account identifier, wherein the data related to the historical spending patterns is used in the comparative analysis of the viable payment options;
data associated with a calendar of a user associated with the account identifier, wherein the data associated with the calendar of the user is used in the comparative analysis of the viable payment options; and
a geographical location of a user associated with the account identifier at a transaction time identified in the set of transaction information or a geographical location of a provider associated with the transaction request at the transaction time identified in the set of transaction information.

20. The method of claim 17, wherein generating the comparative analysis comprises generating a relative score to each of the subset of viable payment options, and wherein selecting a particular payment option from the subset of viable payment options for use in settling the received transaction request comprises:
identifying a user device associated with the account identifier;
transmitting a request for selection of a particular payment option from at least a portion of the subset of viable payment options, wherein the request for selection includes the relative score associated with each of the payment options in the portion of the subset of viable payment options;
receiving, in response to the transmitted request, an indication of a user selection of a particular payment; and
selecting the particular payment selected by the user to settle the received transaction request.
